(19) United States
(12) Patent Application Publication
(10) Pub. No.: US 2024/0087437 A1
(43) Pub. Date: Mar. 14, 2024

(54) SMOKE DETECTOR AND ALARM SYSTEM

(71) Applicant: Nader Nowzari, Oakville (CA)

(72) Inventor: Nader Nowzari, Oakville (CA)

(21) Appl. No.: 18/242,787

(22) Filed: Sep. 6, 2023

Related U.S. Application Data
(60) Provisional application No. 63/406,294, filed on Sep. 14, 2022.
(60) Provisional application No. 63/448,021, filed on Feb. 24, 2023.

(51) Int. Cl. G08B 17/103

(52) U.S. Cl. CPC G08B 17/103

(57) ABSTRACT

A smoke detector and alarm system comprises a base unit comprising a power source, which base unit is hard wired to a smoke detector and alarm to provide an emergency back-up power supply to the smoke detector and alarm unit. The base unit may comprise both AC power from a building and rechargeable batteries, and the smoke detector and alarm unit comprises a power source of AC power as its first source of power and when the AC power is unavailable its second source of power is the back-up power supply. The base unit wirelessly communicates with the smoke detector and alarm unit as well as one or more further smoke detector and alarm units (some of which may additionally comprise a heat detector, or alternative comprise a heat detector rather than smoke detector). The smoke detector and alarm system may play messages through the base unit and smoke detector and alarms in the event that smoke or fire is detected by any smoke detector and alarm. The base unit optionally provides the choice of recording personalized messages rather than factory set. A smoke detector and alarm may comprise a video camera and/or a laser beam light and/or a projector projecting images and/or text. The base unit may also additionally communicate with one or more emergency light/sign units and allow communication with emergency operators. Video cameras on the smoke detector and emergency light unit can allow responders to a fire to see inside the building though a video feed.

### FIELD OF THE INVENTION

The present invention relates to emergency alert systems and more specifically to a smoke detector and alarm system.

### BACKGROUND OF THE INVENTION

Smoke detectors are designed to detect smoke from a fire and alert building occupants through a siren and/or lights alarm system. Heat detectors are designed to detect heat from a fire and also alert building occupants through an alarm system. Heat detectors may be used instead of smoke detectors in locations in which steam or dust would trigger false alarms, such as kitchens, laundry rooms and utility closets. The uses and shortcomings of smoke detectors described herein are applicable to heat detectors. Smoke detectors with batteries need to be tested to ensure that the batteries are not dead. Such testing is not always performed, and battery failure may only be discovered when a smoke detector fails to operate.

The failure of batteries may be avoided with hard wiring smoke detectors or having plug in smoke detectors; however, when the power fails, these detectors also fail unless they have a back-up battery. Also wiring and/or plugs may not be available in all locations, such as locations outside a main building, such as a garage. Batteries kept below freezing have a high likelihood of failing and a smoke detector in a location that has temperatures below freezing may likewise fail to operate. Garage fires are especially problematic since the garage is cut off from the rest of the building so the smoke is not detected by people and/or smoke detectors in the main building, and any smoke detector in the garage may not be operational if batteries have failed due to exposure to below freezing temperatures. Current smoke detectors do not self-test to ensure the unit and battery are functioning.

Even with a smoke detector and alarm system in working order, there may be considerable confusion due to lack of visibility caused by smoke and/or lack of light due to any power outage which may lead to occupants being unable to exit a building.

U.S. Pat. Nos. 10,083,597 and 10,535,237 describe emergency alert systems for alerting aid responders and guiding them to a residence where an individual has suffered a personal incident. A flashing light and/or siren at the front door guides first responders to the correct residence. However, after arriving at a location guided by such an emergency alert system, the first responders may encounter lack of visibility inside caused by smoke and/or lack of light. This causes difficulties for first responders trying to find and rescue occupants and to identify and/or avoid dangers to themselves. Occupants may also be unable to find their way out due to lack of visibility and current smoke detectors do not provide any light other than illuminating under the detector.

A smoke detector and alarm system that has back-up for loss of power to the system so that the system still works, self-tests, provides a lighted and/or guided path for escape or rescue, and aids first responders with communication and location.

### SUMMARY OF THE INVENTION

In an embodiment of the present invention there is a smoke detector and alarm system comprising a base unit comprising a power source, which base unit is hard wired to a smoke detector and alarm unit to provide a back-up power supply to the smoke detector and alarm unit.

In a further embodiment of the smoke detector and alarm system the power source of the base unit comprises both AC power and rechargeable batteries, and wherein the smoke detector and alarm unit comprises a power source of AC power as its first source of power and wherein when the AC power is unavailable its second source of power is the back-up power supply.

In a further embodiment of the present invention there is a smoke detector and alarm with a video camera. This video camera may additionally comprise remote access, and further this remote access may be protected by one or more of encryption and password.

In an embodiment of the present invention there is a smoke detector and alarm system comprising one or more smoke detector and alarm units and a base unit, wherein the base unit comprises pre-recorded messages which will play from the base unit and all the smoke detector and alarms if any of the one or more smoke detector and alarm units sense smoke or fire. Further in this smoke detector and alarm system the base unit may comprise recording means for recording personalized pre-recorded messages.

In an embodiment of the present invention there is an emergency light unit with a video camera. This video camera may additionally comprise remote access, and further this remote access may be protected by one or more of encryption and password.

In an embodiment of the present invention there is a smoke detector and alarm unit with a laser beam light which projects a horizontal beam of light when the smoke detector and alarm unit detects smoke or fire. In this smoke detector and alarm unit the laser beam light also may comprise a projector to project an image or a text or an image and a text to guide a person.

In an embodiment of the present invention there is a smoke detector and alarm system comprising a base unit, and one or more smoke detector and alarm units, which base unit runs a self-test to check that all smoke detector and alarms are functional and have power. In this smoke detector and alarm system the base unit communicates wirelessly with the one or more smoke detector and alarms units. In this smoke detector and alarm system the base unit may optionally communicate with a light or alarm on an exterior of a building in which the base unit is located. In this smoke detector and alarm system the base unit may optionally communicate with one or more of an external emergency services entity and a building owner and a building manager.

In a further embodiment of the present invention there is a smoke detector and alarm system comprising a base unit, and one or more smoke detector and alarm units wherein the one or more smoke detector and alarm units each run a self-test to check that each of the one or more smoke detector and alarms are functional and have power.

In a further embodiment of the present invention, there is a smoke detector and alarm system comprising a base unit, and one or more smoke detector and alarm units, wherein the base unit additionally comprises a panic button and a two-way speaker and microphone, and wherein activating the panic button, either by pressing it or activating it remotely or by voice command, connects the base unit in communication with an emergency service provider.

In a further embodiment of the present invention, there is a smoke detector and alarm system wherein the smoke detector and alarm unit is in communication with an alert sign on an exterior of a building in which the smoke detector and alarm unit is located, which alert sign displays a warning when the smoke detector and alarm unit detects heat or smoke.

### BRIEF DESCRIPTION OF THE FIGURES

These and other aspects of the present invention will be apparent from the brief description of the drawings and the following detailed description in which:

FIG. 1 is a front view of a base unit of an embodiment of the smoke detector and alarm system of the present invention.

FIG. 2 is a right-side view of the base unit of FIG. 1.

FIG. 3 is a back perspective view of the base unit of FIG. 1.

FIG. 4a is a top perspective view of a first smoke detector and alarm unit of an embodiment of the smoke detector and alarm system of the present invention.

FIG. 4b is a top perspective view of a second smoke detector and alarm unit of an embodiment of the smoke detector and alarm system of the present invention.

FIG. 4c is a top perspective view of a third smoke detector and alarm unit of an embodiment of the smoke detector and alarm system of the present invention.

FIG. 4d is a left-side view of the smoke detector and alarm unit of FIG. 4c.

FIG. 5 is a left-side view of the smoke detector and alarm unit of FIGS. 4a and 4b.

FIG. 6a is a front left perspective view of an emergency light unit of an embodiment of the smoke detector and alarm system of the present invention.

FIG. 6b is a back view of the emergency light unit of FIG. 6a.

FIG. 7 is a flow chart of the power supply and of the micro controller of the base unit of FIG. 1.

FIG. 8 is a flow chart of the power supply and of the micro controller of the smoke detector and alarm of FIG. 4.

FIG. 9 is a flow chart of the power supply and of the micro controller of a second embodiment of the smoke detector and alarm of FIG. 4.

FIG. 10 is a flow chart of the power supply and of the micro controller of the emergency light unit of FIG. 6a.

FIG. 11a is a right perspective view of a solar powered emergency sign of an embodiment of the present invention.

FIG. 11b is an exploded view of a solar powered emergency guide light of an embodiment of the present invention.

FIG. 11c is a depiction of a circuit for the solar powered emergency guide light of FIG. 11b.

### DETAILED DESCRIPTION OF THE INVENTION

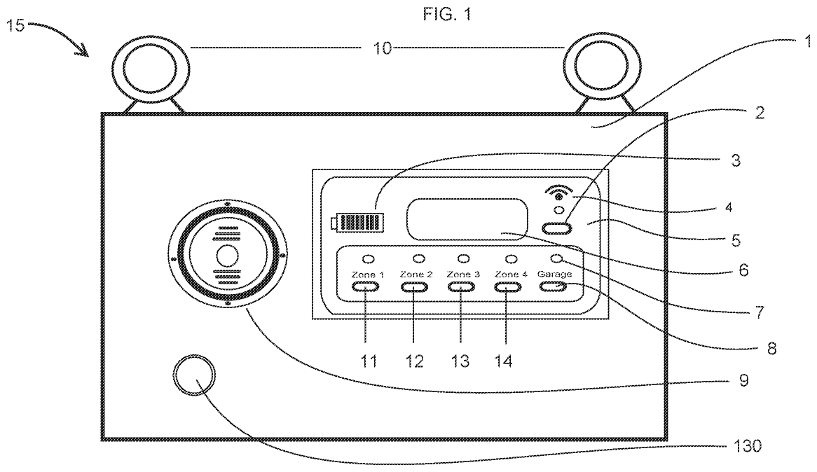

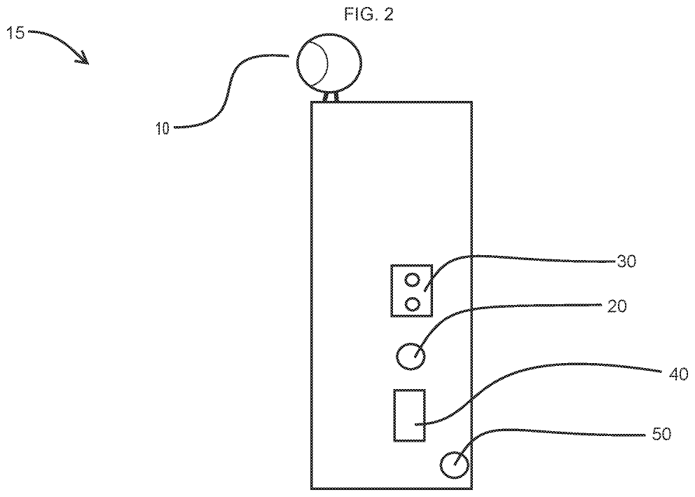

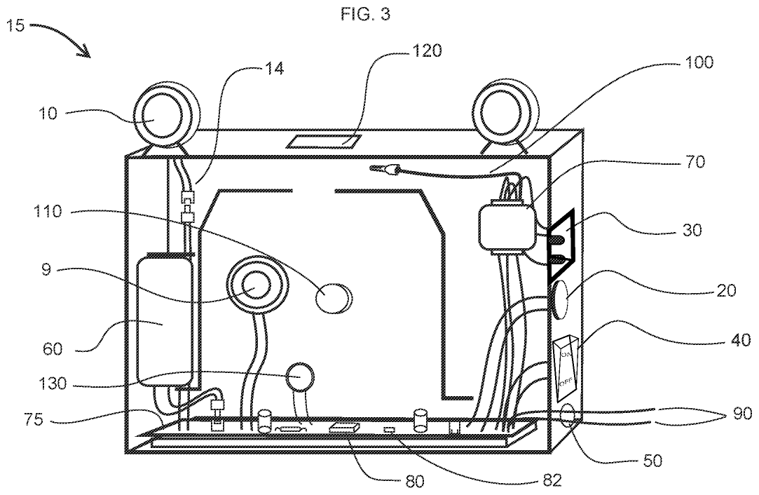

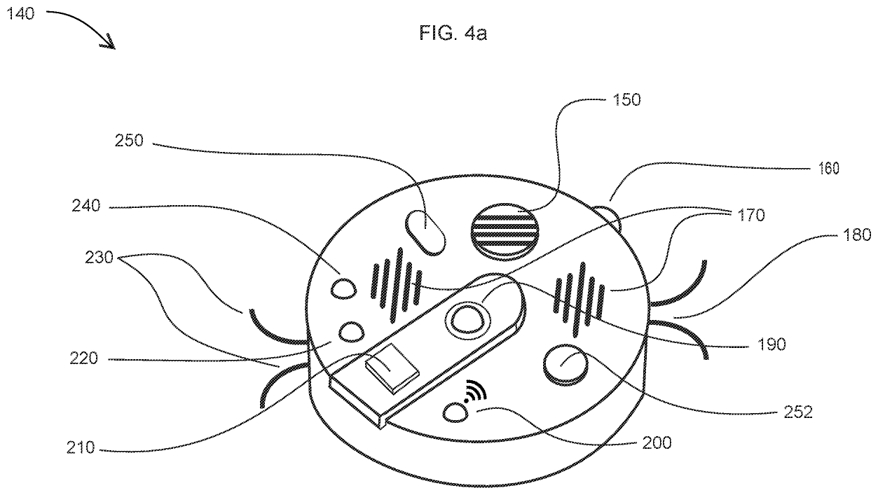

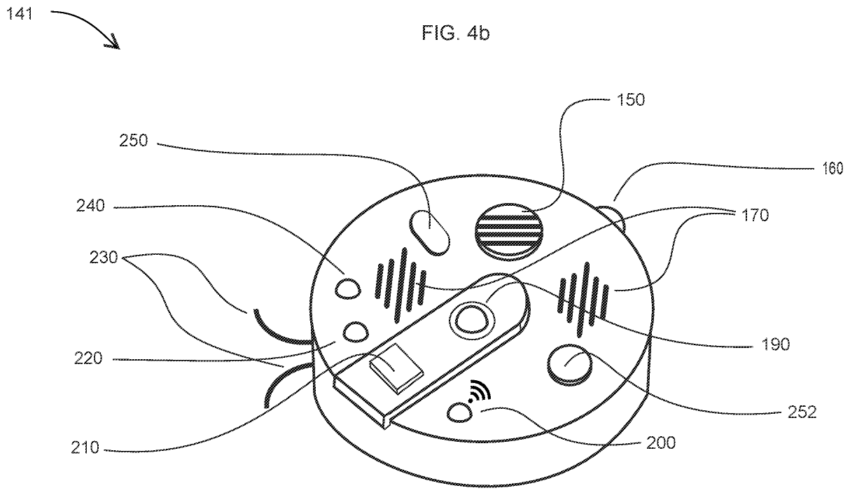

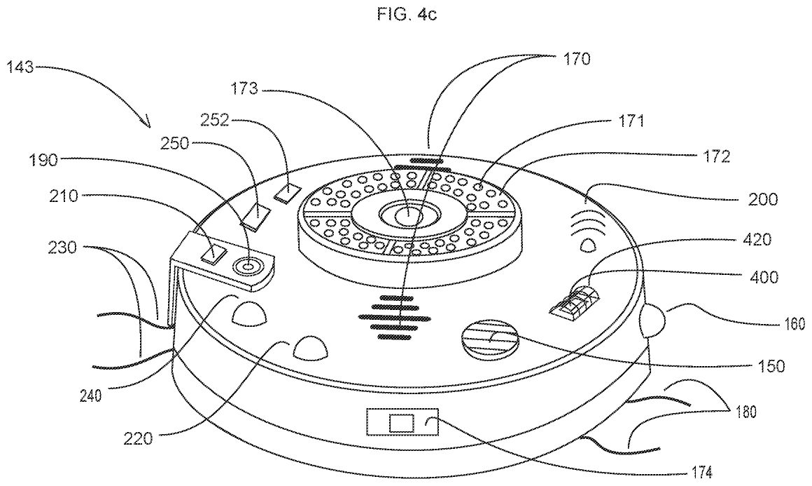

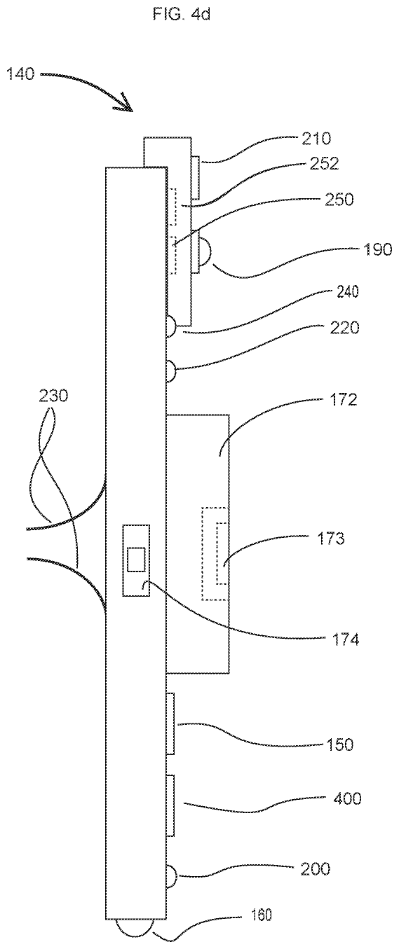

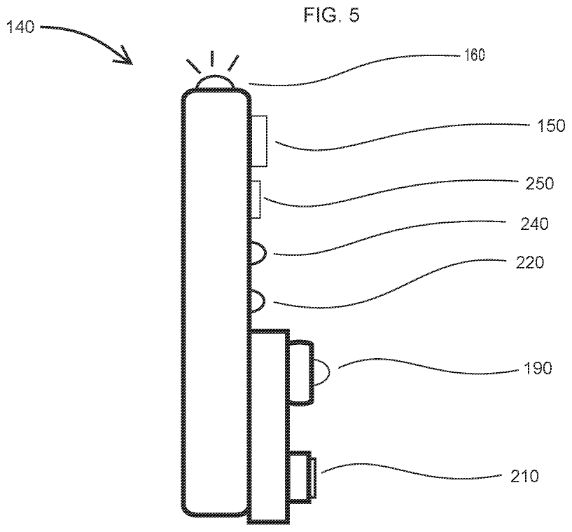

The present invention comprises a base unit 15 that provides an emergency back-up power supply directly to a first smoke detector and alarm unit 140 in a garage or other location in a home or building that is vulnerable to below freezing temperatures or other causes of battery failure. An embodiment of the base unit 15 of the present invention is shown in FIGS. 1 to 3 and a first embodiment of the smoke detector and alarm unit 140 of the present invention is shown in FIGS. 4a and 5. Since battery power can fail in below freezing temperatures the base unit 15 is installed in the basement of a home or another appropriate location within the home or building that is away from below freezing temperatures, to ensure the availability to supply power of the backup battery 60 of the base unit 15 when the power goes out. If power to the building is lost, the back-up battery 60 of the base unit 15 provides power to the smoke detector and alarm unit 140 in a garage or barn (or other outbuilding or location at risk of battery failure due to climate or other unfavorable conditions).

Optionally, the base unit 15 may include a panic button 130 that may be pushed to contact emergency services, or may be activated remotely through a wearable or remote located device. When activated emergency services are automatically contacted. The speaker is two-way and includes a microphone for communication with an emergency operator. The base unit 15 may additionally be voice activated when the panic button 130 or remote panic button (not shown) can't be reached.

In an embodiment of the invention, the base unit 15 wirelessly communicates among all smoke detector and alarm units 140, 141, 143 located in a house or building in which the smoke detector and alarm system of the present invention is installed. The base unit 15 communicates to receive fire and smoke detection warnings from all smoke detector and alarm units 140, 141, 143 as well as to test all smoke detector and alarm units 140, 141, 143. The base unit 15 may be 120-volt, hard-wired to the home/building's power and wireless to connect with the smoke detector and alarm units 140, 141, 143 and any other safety units e.g., an exterior alarm/light. The base unit may be wall mounted for ease of viewing/touching the display panel 5 and to effectively utilize the emergency lights 10.

The base unit 15 may display and provide the controls for the smoke detector and alarm units 140, 141, 143 within the various zones in the house and garage. In this embodiment, the base unit 15 has a cover 1 with a display panel 5, having a message display 6. A master test button 2 allows a test/reset of the base unit 15. The smoke detector and alarm units 140, 141, 143 can be reset from the base unit. To test, the master test button 2 is pushed and held until it beeps and a pre-recorded factory message plays, indicating that the smoke detector and alarm unit 140, 141, 143 is working.

Zone test buttons 11-14, 8, namely zone 1 test button (11), zone 2 test button (12), zone 3 test button (13), zone 4 test button (14) and garage test button (8). Each zone has a smoke detector and alarm unit 140, 141, 143 in it. When a zone test button 11-14, 8 is pushed and held it will trigger the corresponding smoke detector and alarm unit 140, 141, 143 to emit the appropriate alarm and a message on the message display 6 will appear indicating that the particular smoke detector and alarm unit 140, 141, 143 is working. To reset/silence the particular smoke detector and alarm unit 140, 141, 143, the corresponding zone test button 11-14, 8 is pushed twice. To test all the zones, the master test button 2 is pushed twice and then each zone can be tested by pushing the particular zone test buttons 11-14, 8 after which a pre-recorded factory message plays indicating that the smoke detector and alarm units 140, 141, 143 are working. On the display panel 5 the battery icon 4 indicates the available battery life.

It will be understood that a base unit 15 can be designed to include more than five zones for larger properties. It will be understood that while the smoke detector and alarm system is being described herein in a home, the present invention may be expanded for use in larger installations.

Above each zone test button 11-14, 8 is a corresponding zone indicator light 7 which may be colored or white lights or a combination, and when the light is on this indicates that zone's smoke detector and alarm unit 140, 141, 143 is engaged. An indicator light 7 remains steady to indicate it is working. If an indicator light 7 flashes, then that signals to the homeowner there is an issue with connectivity to Wi-Fi or connectivity to the smoke detector and alarm unit 140, 141, 143. It will be understood that other alerts may be used to indicate problems with connecting to the smoke detector and alarm units 140, 141, 143.

The zone test buttons 11-14, 8 are used to test a particular zone to ensure the zone's smoke detector and alarm unit 140, 141, 143 is working. Each zone can be tested individually to ensure that each smoke detector and alarm unit 140, 141, 143 is in working condition. Examples of zone areas include: zone one—the kitchen, zone two—the main level hallway, zone three—upper level hallway, zone four—lower level hallway/basement, and garage.

There is an icon of a battery 3 showing the available ‘life’ of the battery power supply. There is a colored or white Wi-Fi indicator light 4 demonstrating that the Wi-Fi signal is working. This light is steady and if it flashes, then that signals to the homeowner there is an issue with connectivity.

Two emergency lights 10 located on the top of the base unit 15 go on in the event of a power outage. These lights are supplied power by back-up batteries within the unit. The lights can be adjusted and positioned to different angles to illuminate a path. On the side of the base unit there is an emergency light test button 20 to ensure that the emergency lights are working.

A base speaker 9 within the base unit 15 provides a siren type alarm and/or a pre-recorded voice message to be produced when a smoke detector and alarm unit 140, 141, 143 is activated because of the presence of smoke or fire. The system may be set so that when the base unit 15 receives a signal from one smoke detector and alarm unit 140, 141, 143, the base unit 15 will trigger all the other smoke detector and alarm units 140, 141, 143 to produce a siren alarm and flashing strobe light e.g. after 30 seconds. The smoke detector and alarm unit 140, 141, 143 that detected smoke or fire will activate its siren and strobe light immediately, and may additionally have a message announcing the presence of smoke or fire in that zone. Announcing the location of smoke detector and alarm that detected smoke or fire allows an occupant of the building or home to escape in an appropriate direction rather than towards the danger. The prerecorded announcement or personalized message can be set to play after an alarm so that it can be heard and also in case there is a false alarm. The message plays across all the smoke detector and alarm units and base unit so that the danger may be avoided.

As seen in FIG. 2 and FIG. 3 (which does not include the cover 1), on the side of the base unit 15 is an on/off switch 40. The base unit 15 can be turned off during maintenance or battery test or emergency lights test. The inlet 30 provides an opening for the AC power insert: a male plug-in inlet provided for 120 volt to be used in North America and 220 voltage power for areas with higher voltage which can be connected to cord 100 (shown in FIG. 3) to supply power to the base unit 15, and the outlet 50 provides an opening for the DC power cords 90 that supplies DC power to the smoke detector and alarm unit 140 in the garage. Cords (not shown) provide power through the display panel outlet 110 to the display panel 5 (shown in FIG. 1).

Internally in the base unit there may be one or more rechargeable batteries 60 providing hours of power during a power outage to the smoke detector and alarm unit 140 in the garage and to the emergency lights 10 on the base unit powered through lights cords 24 from the battery 60. The batteries 60 are recharged via battery charger 86. When the power is on the batteries are automatically being charged. The rechargeable batteries can be easily replaced when needed. There is a transformer 70 or a more efficient AC/DC switching power supply.

A circuit board 75 containing a computer controls all the functionality. An SD memory chip/card 85 saves messages. A wireless communication module 82 (Wi-Fi or Bluetooth) communicates with all the smoke detector and alarm units 140, 141, 143 with capabilities to connect to the internet through the house router. Internet can be used to send notifications and alerts similar to the cellular radio as an alternative.

Optionally a cellular radio module with a subscription SIM card 80 can provide wireless communication. The system will send an alert message to up to five individuals and send an alert call to an external emergency services entity reporting the incidence if the alarm is not reset by the homeowner within minutes. The base unit 15 can additionally be set to also or alternatively report to a building owner and a building manager These alert messages may be pre-recorded at the time of installation. It is possible for the homeowner to supply their personal contact details with emergency services so that when the alarm is triggered an emergency services responders has all the pertinent data such as homeowner's name(s), address/major intersection, number of family members, pets, presence of home oxygen, residents with mobility issues, possible health issues such as autistic members, emergency contact names and numbers.

The base unit 15 automatically runs a test every month to ensure all smoke detector and alarm units 140, 141, 143 are in working condition. It will also test the batteries. This self-test may be set to run monthly or any other time interval A microcontroller in the circuit board 75 is programmed in the factory to run a test every 30 days (or other set time) and set as day zero. When the homeowner installs and runs a test by pressing base self-test button 18, that day is registered as the first day and then the self test will run every 30 days thereafter. The date will be shown on the message display 6. This self-test works the same way for the smoke detector and alarm units 140, 141, 143 shown in FIGS. 4a and 4b by pressing detector self-test button 252.

In an embodiment of the present invention, in the event of failure the message display 7 gives information on the failure, an alarm will sound on the base unit 15, and optionally a ‘red’ alert message will be texted to the homeowner. The results of these monthly tests may be texted to the homeowner on a monthly basis. Each smoke detector and alarm unit 140, 141, 143 does a self-test each month to ensure that it is functioning properly.

To prevent electrocution a pop-up safety switch 84 located inside the base unit 15 automatically shuts the power off if the front panel 1 is removed. A base unit bracket 120 may be included to undermount the smoke detector and alarm unit 140, 141, 143 on a cabinet or shelf

The life of the battery 60 and testing the smoke detector and alarm units 140, 141, 143 can be tested via Wi-Fi or Bluetooth to ensure the system is active and working.

The base unit 15 and all smoke detectors and alarm units 140, 141, 143, including the one located in the garage may be connected wirelessly to an outside emergency light and/or audible alarm such as that described in U.S. Pat. Nos. 10,083,597 and 10,535,237. The base unit 15 may also be wired to have the main entrance door unlocked externally in an emergency situation.

FIGS. 4a and 5 show a first smoke detector and alarm unit 140 of an embodiment of the smoke detector and alarm system of the present invention. FIGS. 4b and 5 show a second smoke detector and alarm unit 141 of an embodiment of the smoke detector and alarm system of the present invention. The difference between the first smoke detector and alarm 140 and the second smoke detector and alarm 141 is that the first smoke detector and alarm 140 has DC power cords 180 and AC power cords 230 and the second smoke detector and alarm 141 has AC power cords 230. Optionally, the first smoke detector and alarm 140 also does not comprise back up batteries. Alternatively, the smoke detector and alarm 140, 141, 143 could be identical so that it could be used in a garage and inside the building, namely it would look like the smoke detector and alarm 140 in FIG. 4a and also have batteries inside it.

FIGS. 4c and 4d show a third smoke detector and alarm unit 143 of the present invention which additionally comprises a heat detector. The heat detector may be fixed-temperature and/or rate of rise detector and in this embodiment both fixed-temperature and rate of rise functionality is present. Further, in this embodiment a bimetallic fixed-temperature system is described but a fusible link or quick metal system could be used. Including the rate of rise detector allows for use in an unheated location such as garage or car port since the non-metallic diaphragm can operate at low temperatures. The third smoke detector and alarm unit 143 shown in FIGS. 4c and 4d has the components of the first smoke detector and alarm unit 140 plus a heat collector 172 with air vents 171 with the components of the rate of rise heat detector system within, and a cavity 173 within which is a bi-metallic disc (not shown) and the components of the fixed-temperature system within. A thermistor/temperature control switch 400 has an optional cover 420 (not shown in FIG. 4d). The thermistor resistance responds to temperature while it is increasing. When the ambient temperature reaches the above factory setting e.g. of 135 F, the thermistor kicks in and activates the alarm and the alarm will sound. The thermistor works like an On and Off switch. When the temperature cools down the thermistor turns off and disconnects the alarm and resets back to resting state.

The third smoke detector and alarm 143 may have the smoke detector capability turned off. The circuit board within the smoke detector and alarm 143 supplies power to both the smoke alarm and the heat detector. An optional ON/OFF switch 174 on the side of the alarm allows the user to cut off the power to the smoke alarm section which is helpful when it will be used in areas in which steam or dust levels can cause false alarms. Finally, a fourth embodiment of the invention is a heat detector and alarm unit (not shown) with which the base unit 15 communicates that does not include the components of a smoke detector, for use in areas in which the smoke detector would be set off e.g. due to high levels of steam or dust.

The first smoke detector and alarm unit 140 or the third smoke detector and alarm unit 143 in the garage (or other location at risk of battery failure due to climate or other unfavorable conditions) is hard wired to the AC mains and in the event of power failure has DC power supplied by the backup battery 60 of the base unit 15. The second smoke detector and alarm 141 may be hard wired to AC mains through its AC power cords 230 or take power from its batteries (not shown).

In this embodiment, of the four smoke detector and alarm units 141 in the four zones (not including the garage) there is preferably at least one or more smoke detector and alarm unit 141 that is hard-wired to the home's wiring for emergency back-up power supply and the other three smoke detector and alarm units 141 utilize battery power. All smoke detector and alarm units 141 in the four zones (and optionally the smoke detector and alarm units 140 in the garage) have rechargeable batteries (not shown) and the smoke detector and alarm units 140, 141, 143 that are hard wired are connected to 120V AC mains. All of the smoke detector and alarm units 140, 141, 143 have wireless capability.

In case of fire or power outage the battery (not shown) in each device will provide power to the smoke detector and alarm unit 141. If smoke or fire is detected it triggers the smoke detector and alarm unit 140, 141, 143 to start a siren heard through an alarm speaker 150, start flashing a strobe light 210, switch on a laser beam 160 and optionally play an announcement that there is possible smoke or fire.

The wireless and hard-wired smoke detector and alarm units 140, 141, 143 have a built-in video camera 190. The purpose of this video camera 190 is to allow first responders to access a video feed to view the area in jeopardy as well as show a potential pathway to the hot spot, a trapped individual or escape route. The video feed is accessible through an App (which may be password and/or encryption protected) so that the video camera can be activated and firefighters or rescue workers can view inside the building. Optionally the reset of the smoke detector and alarm unit 140, 141, 143 automatically resets the video camera to password/encryption protected mode or turns off the video camera.

In an embodiment of the present invention, each of the smoke detector and alarm units 140, 141, 143 have the ability to pre-record an announcement that this unit 140, 141, 143 is for this particular zone, for example, “Zone 1 fire or smoke in the kitchen”. FIG. 1 shows an optional record button 16 and microphone 17 which allows a user to push the record button 16 to record their own personalized message.

There is a laser beam 160 located on the side of the smoke detector and alarm unit 140, 141, 143 and during installation the laser beam 160 should be pointed to the nearest exit door. In case of fire/smoke the laser beam 160 will illuminate with a beam of light pointing horizontally towards the exit door/direction. Optionally the laser beam 160 may project a projected image/text pointing to the exit door/direction, such as, an arrow or the words “Exit” or “This way out” etc.

Each smoke detector and alarm units 140, 141, 143 has a built-in strobe light 210 that will be activated when the smoke detector and alarm unit 140, 141, 143 is triggered by smoke or fire. There is a built-in siren heard through the alarm speaker 150 that gets activated when smoke or fire is detected. When a smoke detector and alarm unit 140, 141, 143 detects smoke or fire it sends a wireless signal to the base unit 15.

All smoke detector and alarm units 140, 141, 143 are capable of detecting smoke, fire and cardon monoxide through entry slots 170. The detector silence/test button 250 is pressed to test the smoke detector and alarm 140, 141, 143 which then emits a beep if working, and to silence it from a false alarm e.g. cooking fumes. To avoid falls or accidents as a result of homeowners or individuals testing the smoke detector and alarm units 140, 141, 143 by pressing the unit silence/test button on a difficult to reach smoke detector and alarm 140, 141, 143, a remote may be used to test the batteries of the smoke detector and alarm units 141. To test the smoke detector and alarm units 140 the homeowner can aim the remote towards the zone device by pushing the test button on the remote to activate and the test results in a beeping sound.

As explained above, the smoke detector and alarm 140, 141, 143 also self-tests similarly to the base unit 15. The smoke alarm is programmed in the factory to run a test every 30 days (or other period) and it will be set as day zero. When the homeowner installs and runs a test by pressing self-test button 252, that day is registered as the first day and then the self test will run every 30 days thereafter. In a typical smoke detector and alarm unit 140, 141, 143 the life time will be 10 years.

A hard-wired smoke detector and alarm unit 140 which has wireless connectivity is installed in the garage. This unit's power is supplied by a 120/220 volt directly from the AC's house power and a low DC voltage from the back-up battery 60 located in the base unit 15. This smoke detector and alarm unit 140 in the garage can be supplied with a rechargeable battery that withstands low temperatures but it does not need to have a battery if it is powered by the 120V AC and the emergency back-up battery located in the base unit 15 during a power outage.

The smoke detector and alarm units 140 in the garage is the only smoke detector and alarm unit 140 that receives its power via the emergency back-up base unit 15. This unit 140 is hard-wired through the unit DC power cords 180 to the base unit 15. Apart from the DC power connection and possible lack of battery, the smoke detector and alarm unit 140 in the garage is otherwise the same as the other smoke detector and alarm units 141.

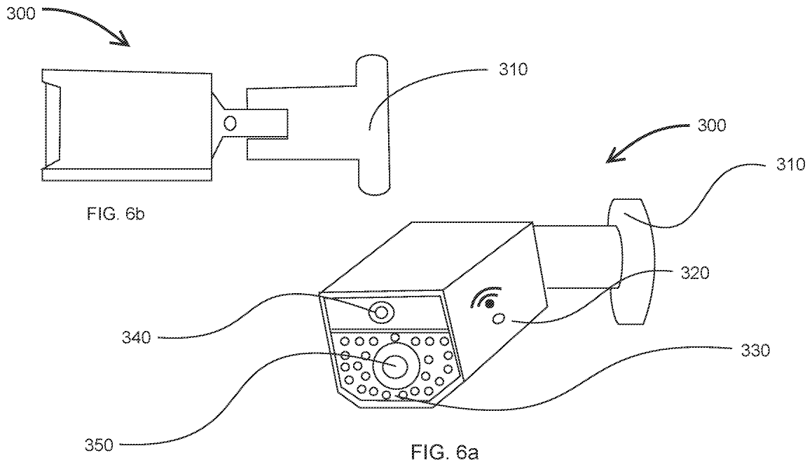

FIGS. 6a and 6b show an emergency light unit 300 of an embodiment of the smoke detector and alarm system of the present invention. These wireless emergency light units 300 with a video camera 350 are installed in corridors/pathways of a building or home to help illuminate an escape route when the base unit 15 is triggered by a smoke detector and alarm unit 140, 141, 143. The base unit 15 will send a signal via Wi-Fi to activate these wireless emergency lights thus illuminating a pathway to safety. The connectivity with Wi-Fi on the smoke detector and alarm units 140, 141, 143 is shown by the Wi-Fi indicator 200. The presence of AC power on the smoke detector and alarm units 140, 141, 143 is indicated by the power indicator 240, the presence of battery power is indicated by the battery indicator 220.

These wireless emergency light units 300 have built-in light unit video camera 350. The purpose of this video camera is to allow first responders to access a video feed to view the area in jeopardy as well as show a potential pathway to the hot spot, a trapped individual or escape route. The wireless emergency light units 300 have a built-in laser light 340 located on the side of the light and during installation the laser light 340 should be pointed to the nearest exit door. The laser light 340 could also comprise a projector to project text or an image showing an exit door/direction. The wireless emergency light units 300 may also have LED lights 330 and light unit Wi-Fi connectivity indicator 320. The wireless emergency light units 300 may be installed with a bracket attachment 310.

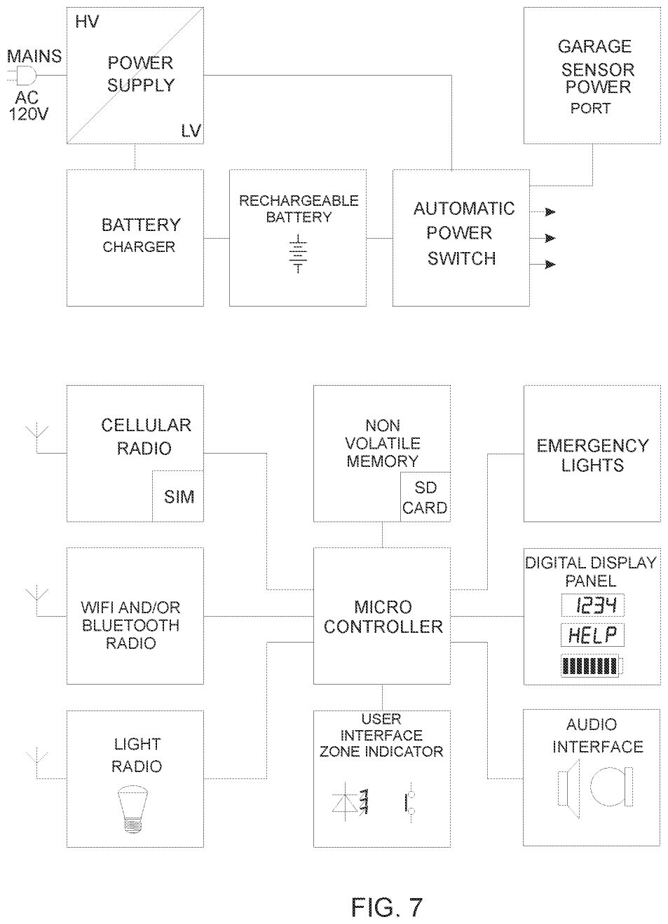

FIG. 7 is a flow chart of the power supply and of the micro controller of the base unit 15 of FIG. 1.

Power Supply

This may be the transformer 70 or a circuit comprising of an AC mains rectifier and a HV(High Voltage) DC to LV(Low Voltage) DC power converter. It converts the 120V AC into a low DC voltage supplied to the rest of the circuits.

Battery Charger 86

A circuit that monitors and charges the rechargeable battery according to its chemistry and specifications (voltage, current, capacity).

Rechargeable Battery 60

One or more rechargeable battery cells 60 capable of providing a few hours of full emergency operation in case of AC mains failure.

Automatic Power Switch 40

A circuit that routes power to the rest of the circuits either from AC mains or battery. In absence of AC mains power it switches power to the rest of the circuits to the rechargeable battery 60.

Microcontroller—Base Unit

A circuit board 75 comprising of a computational chip (microcontroller/cpu) running a program (firmware/software) performing all the system functional tasks. This is controlling and exchanging information with all the other circuits in the base unit 15 and the rest of the system, either directly or through the radio channels provided.

Digital Display 5

A visual user interface that may contain an LCD display, discrete LED indicators or any other indicators by visual means. This is controlled by Microcontroller.

Emergency Lights 10

One or more light sources in case of emergency or AC mains power loss.

Audio Interface

An audio interface circuit containing a speaker 9, a microphone 17 and required electronics for sound generation and sound recording of custom audio messages. It is connected to the microcontroller.

User Interface Zone Indicator

A user input/output interface (e.g. buttons, keys, optical indicators) for human interaction with the system. Among all the control features it mainly allows user to quickly test and diagnose the state of the system.

Cellular Radio

A radio module used to connect to a cellular service based on subscription (or for free emergency line calls only). It is used to report an incident to owner, or any other third parties if necessary, and ultimately by making calls to emergency services lines.

WiFi or Bluetooth Radio 82

A radio module 82 used to connect all system sensors to the base unit. In case of Wi-Fi, it can be used to connect to the internet thru the house access point.

With adequate internet services, it can perform the emergency service line calls and other features provided by the cellular radio.

Emergency Alert Light Radio

A radio transmitter/remote control may be used to control any of an outside emergency alert light/alarm described in U.S. Pat. Nos. 10,083,597 and 10,535,237, including through Wi-Fi.

Non Volatile Memory

A memory circuit (e.g. integrated circuit memory chip 85, a replaceable SD memory card 85 or USB memory stick) used to store the audio messages for incident reporting and other system configuration settings. Information stored does not get lost in case of a power loss.

Garage Sensor Power Port

A circuit on the circuit board 75 supplying and conditioning (regulating voltage and current) power to the garage unit.

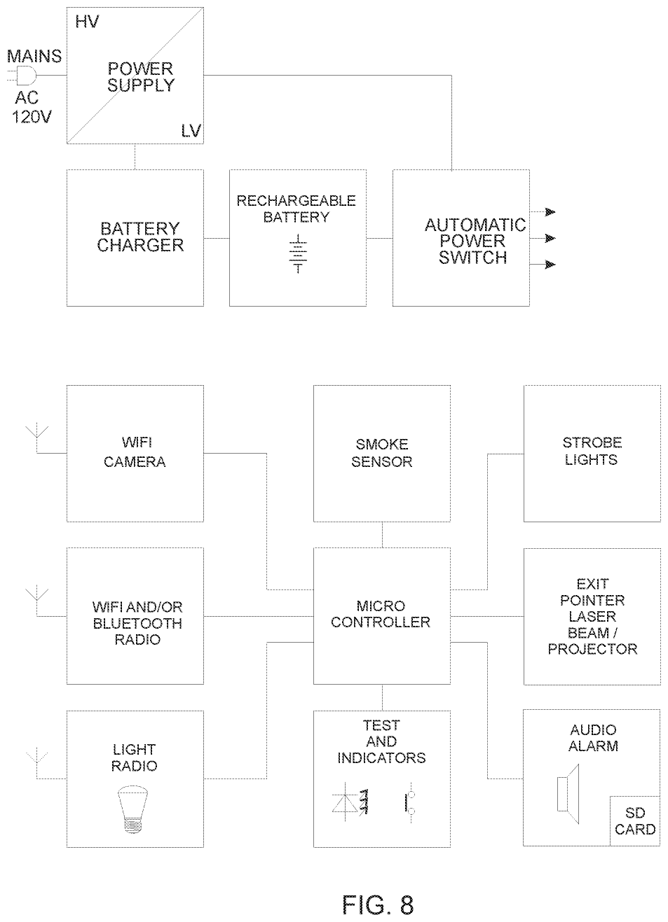

FIG. 8 is a flow chart of the power supply and of the micro controller of the second smoke detector and alarm of FIG. 4b which is used in zones one to four. The blocks with the same name as in FIG. 7 have the same description as set out above in the description of FIG. 7.

WiFi Camera

A WiFi enabled video camera 190 that can be used to visually monitor the incident or installation area. Normally, it is encrypted and protected from any unwanted access but in case of an incident the camera access point may be open for free access by the emergency response team. After the incident the camera returns to protected access upon reset of the system or at any time by owner control.

Audio Alarm

A speaker 150 or any other alarming device by means of sound for local alerting.

May be capable of reproducing a recorded voice message on a non volatile memory.

Exit Pointer Laser Beam/Projector 160

A source of light capable of producing a light beam or a visual image projection in the direction of the exit path in case of emergency.

Microcontroller—Detector Units

A circuit comprising of a computational chip (microcontroller/cpu) running a program (firmware/software) performing all the sensor functional tasks. This is exchanging information with the system base unit 15 through the radio channels provided.

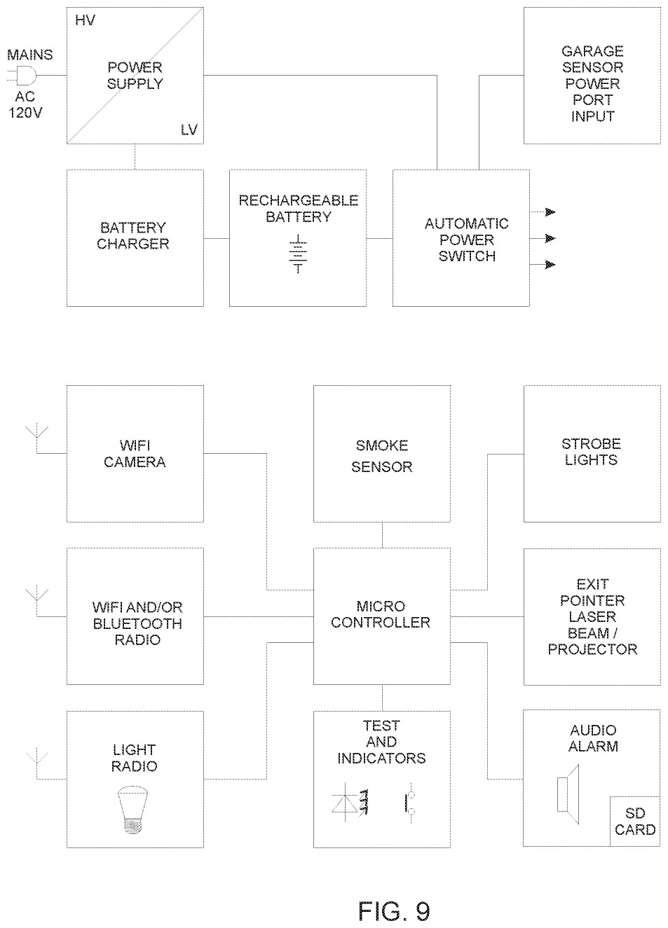

FIG. 9 is a flow chart of the power supply and of the micro controller of the first smoke detector and alarm 140 of FIG. 4a used in the garage (and the third smoke detector and alarm 143 would work similarly but additionally comprise the heat detector functionality). It operates the same as the smoke detector and alarm 141 described above except for the additional Garage Sensor Power Port Input. A circuit routing the power from the base unit 15 to the garage unit 140 circuitry. It works in parallel with the AC mains input and connects the internal rechargeable battery 60 of the base unit 15.

The first smoke detector and alarm 140 may receive power from three different sources:
1. 120 AC from the house power/city;
2. DC low voltage power (could be voltage from 4-9 volts) from the base unit 15 back-up battery 60; and
3. A rechargeable battery within the smoke alarm (not shown in the figures).

In case there is a power outage and the base unit 15 is malfunctioning so that both fail to supply power to the first smoke detector and alarm 140, then the rechargeable battery within it will kick in.

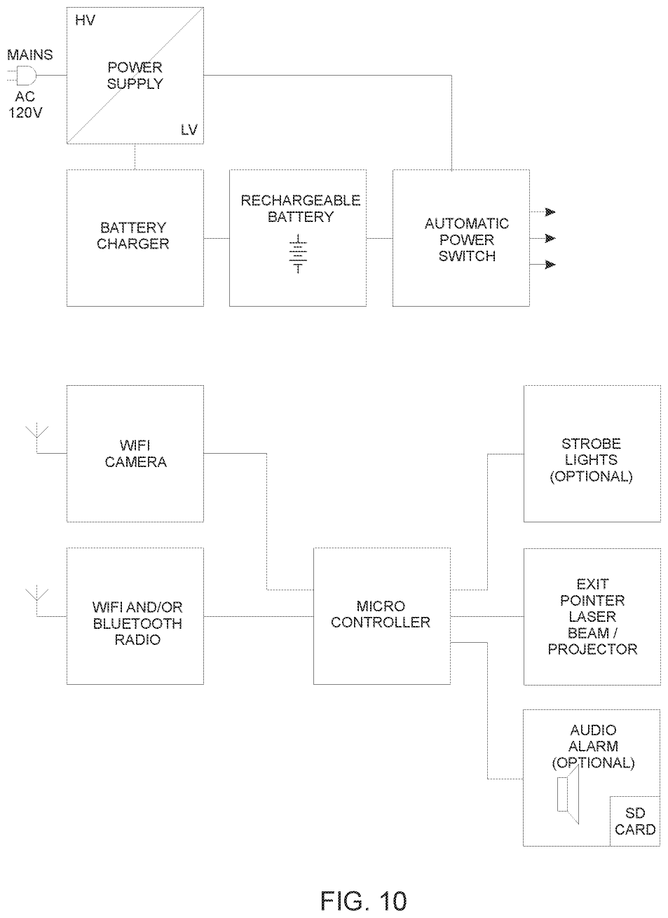

FIG. 10 is a flow chart of the power supply and of the micro controller of the emergency light unit 300 of FIG. 6a. The blocks have the same meanings as described above.

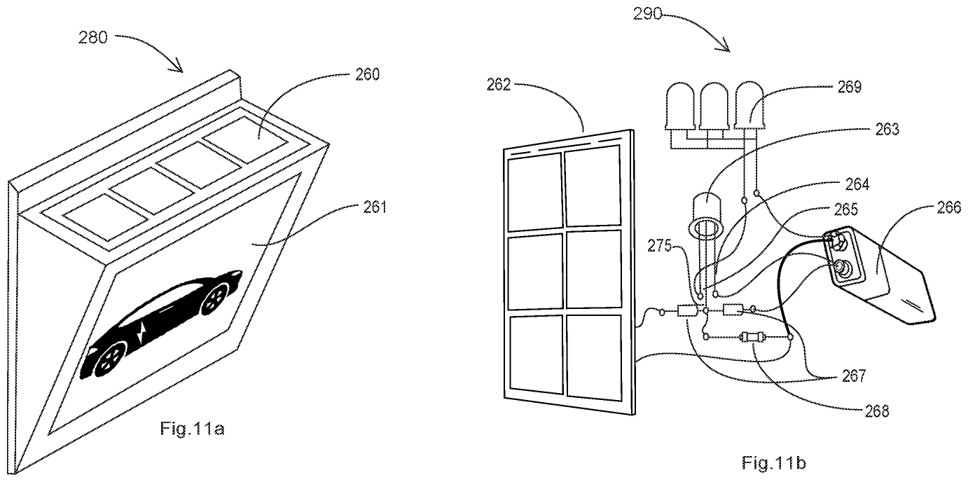

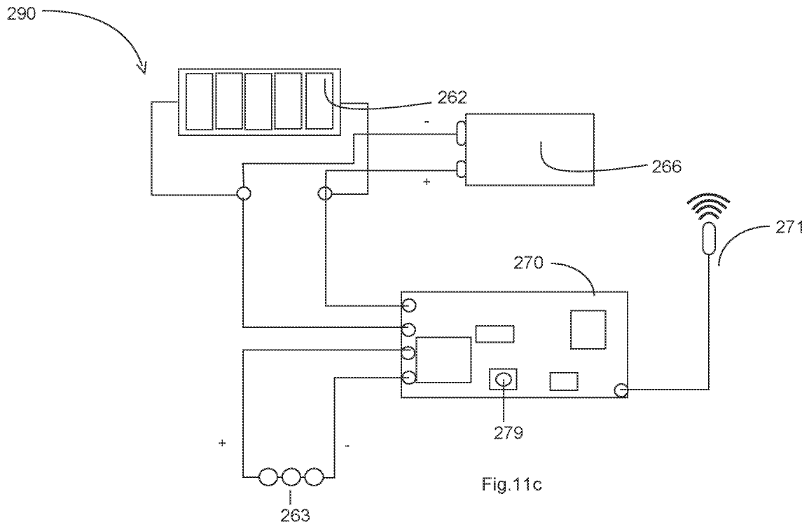

Given the isolation of a garage or other outbuilding or potentially hazardous contents, a first smoke detector and alarm unit 140 in such a location may additionally be remotely connected to an alert sign 280 shown in FIG. 11a mounted outside that garage or outbuilding etc., comprising a display panel 261 and in this embodiment a sign's solar panel 260. When smoke or heat is detected the unit communicates with the alert sign which displays white lights at night and red lights during an emergency, and may also display an appropriate alert, such as, that there is a battery powered car inside, which is very dangerous to fire fighters as it may explode in a fire. The connection may be Wi-Fi or RF remote control.

A first smoke detector and alarm unit 140 (not shown) may additionally be remotely connected to an emergency guide light 290 as shown in FIG. 11b mounted outside that garage or outbuilding etc., which displays white lights at night and red lights during an emergency, and may be solar and battery powered. There are many ways to construct the solar powered emergency guide light 290 and, in the embodiment, shown in FIG. 11b the detector communicates through a transistor 263 which is connected via a base wire 265 to a resistor 268 and to two diodes 267, one of which connects to a solar panel 262 and the other to the positive terminal of a battery 266. An emitter wire 264 also connects to the positive terminal of the battery 266, and the resistor 268 also connects to the negative terminal of the battery 266. A collector wire 265 also connects to LED light(s) 269, and the LED light(s) 269 are also connected to the negative terminal of the battery 266. Again, the connection may be Wi-Fi or RF remote control.

FIG. 11c is a depiction of a circuit showing how the solar powered emergency guide light 290 shown in FIG. 11b is activated. A circuit board 270 with a learning button 279 receives a signal that is picked up by an antenna 271.

The smoke detector and alarm system of the present invention has back-up for loss of power to the system so that the system still works, self-tests, provides a lighted and/or guided path for escape or rescue, and aids first responders/emergency operators with communication and location.

While embodiments of the invention have been described in the detailed description, the scope of the claims should not be limited by the preferred embodiments set forth in the examples, but should be given the broadest interpretation consistent with the description as a whole.

What is claimed is:

1. A smoke detector and alarm system comprising a base unit further comprising a power source, which base unit is hard wired to a smoke detector and alarm unit to provide a back-up power supply to the smoke detector and alarm unit.

2. The smoke detector and alarm system of claim 1 wherein the power source of the base unit comprises both AC power from a building and rechargeable batteries, and wherein the smoke detector and alarm unit comprises a power source of AC power as its first source of power and wherein when the AC power is unavailable its second source of power is the back-up power supply.

3. The smoke detector and alarm system of claim 2 wherein the base unit wirelessly communicates with the smoke detector and alarm unit as well as one or more further smoke detector and alarm units.

4. The smoke detector and alarm system of claim 3 wherein one or more of the smoke detector and alarm unit and the one or more further smoke detector and alarm units may comprise a heat detector.

5. The smoke detector and alarm system of claim 3 wherein one or more of the smoke detector and alarm unit and the one or more further smoke detector and alarm units may be replaced with a heat detector with which the base unit also wirelessly communicates.

6. The smoke detector and alarm system of claim 3, wherein the smoke detector and alarm unit and the one or more further smoke detector and alarm units additionally each comprise a laser beam light which turns on when smoke or fire is detected to project a horizontal beam of light.

7. The smoke detector and alarm unit of claim 6 in which the laser beam light also comprises a projector to project an image and/or a text to guide a person to safety.

8. The smoke detector and alarm system of claim 3, wherein the smoke detector and alarm unit and the one or more further smoke detector and alarm units additionally each comprise a video camera which is remotely accessible.

9. The smoke detector and alarm system of claim 1 wherein the base unit wirelessly communicates with the smoke detector and alarm unit as well as one or more further smoke detector and alarm units and wherein the base unit causes the smoke detector and alarm unit and one or more further smoke detector and alarm units to each run a self-test to check that they are functional and have power.

10. The smoke detector and alarm system of claim 9 wherein the base unit comprises pre-recorded messages which will play from the base unit and the smoke detector and alarm unit and one or more further smoke detector and alarm units if any of them sense smoke or fire.

11. The smoke detector and alarm system of claim 10, wherein the base unit comprises recording means for recording personalized pre-recorded messages.

12. The smoke detector and alarm system of claim 3 wherein the base unit additionally communicates with one or more emergency light units which comprise a light and a video camera which is remotely accessible.

13. The smoke detector and alarm system of claim 3, wherein the base unit comprises zone test buttons and each zone has at least one of the smoke detector and alarm unit or further smoke detector and alarm units in it and wherein when a zone test button is pushed and held it will trigger a corresponding smoke detector and alarm unit to emit an alarm if it is working.

14. The smoke detector and alarm system of claim 13 in which the base unit may additionally comprise a message display and when a zone test button is pushed a message will appear on the message display indicating if the one of more of the smoke detector and alarm unit or further smoke detector and alarm unit is working.

15. The smoke detector and alarm system of claim 2, wherein the base unit additionally comprises one or more emergency lights powered by the batteries which turn on in the event of a power outage.

16. The smoke detector and alarm system of claim 15 in which the base unit additionally comprises a test button to test whether the one or more emergency lights are working.

17. The smoke detector and alarm system of claim 3, wherein the base unit additionally comprises a base speaker which produces an audible alarm when the smoke detector and alarm unit or one or more further smoke detector and alarm units detects the presence of smoke or fire.

18. The smoke detector and alarm system of claim 18, wherein the base unit additionally triggers all of the smoke detector and alarm unit and one or more further smoke detector and alarm units to produce an audible and/or visual alarm when one or more of the smoke detector and alarm unit or one or more further smoke detector and alarm units detects smoke or fire.

19. The smoke detector and alarm system of claim 2 wherein the base unit automatically runs a self-test to determine if any components are not working and the frequency of the self-test is settable.

20. The smoke detector and alarm system of claim 1, wherein the base unit communicates with one or more of: a light or alarm on an exterior of a building in which the base unit is located, a security company, a fire department, a building manager and a building owner.

21. The smoke detector and alarm system of claim 2, wherein the base unit additionally comprises a panic button and a two-way speaker and microphone, and wherein activating the panic button, either by pressing it or activating it remotely or by voice command, connects the base unit in communication with an emergency service provider.

22. The smoke detector and alarm system of claim 2, wherein the smoke detector and alarm unit is in communication with an alert sign on an exterior of a building in which the smoke detector and alarm unit is located, which alert sign displays a warning when the smoke detector and alarm unit detects heat or smoke.
